(19) United States
(12) Patent Application Publication
(10) Pub. No.: US 2004/0013856 A1
(43) Pub. Date: Jan. 22, 2004

(54) Reflective articles and method of making

(76) Inventors: Yoshinori Araki, Higashine-city (JP); Yorinobu Takamatsu, Sagamihara-city (JP)

Correspondence Address: 3M INNOVATIVE PROPERTIES COMPANY, PO BOX 33427, ST. PAUL, MN, 55133-3427, US

(21) Appl. No.: 10/418,000

(22) Filed: Apr. 17, 2003

(30) Foreign Application Priority Data
Apr. 18, 2002 (JP) 2002-116064

(51) Int. Cl. B32B 3/28

(52) U.S. Cl. 428/167

(57) ABSTRACT

A reflective sheet comprising a prismatic layer and a seal layer is provided. The prismatic layer comprises cells of prismatic projections surrounded by raised elements. The height of the raised elements is greater than the height of the prismatic projections. The seal layer is adhered to the raised projections. A space or gap is provided between the peaks of the prismatic projections and the seal layer. The seal layer comprises a crystalline polymer, a self-adherent polymer and an inorganic pigment. The seal layer acts as an adhesive layer to adhere the reflective sheet to a substrate. The self-adherent polymer is compatible with the crystalline polymer at a temperature equal to or higher than the melting point of the crystalline polymer. There is a high peel strength between the seal layer and raised elements. The reflective sheet is easily positioned on the substrate prior to it being finally adhered the substrate.

### CROSS REFERENCE TO RELATED APPLICATION

This application claims priority from Japanese Application 2002-116064, filed Apr. 18, 2002.

### FIELD OF THE INVENTION

This invention relates to reflective articles and methods of making reflective articles.

### BACKGROUND

Reflective articles, including reflective sheets, which utilize a plurality of prismatic projections as reflective elements are known. Such articles, sometimes also referred to as retroreflective articles, are disclosed in U.S. Pat. No. 4,025,159 (corresponding to JP-A-52-110592), U.S. Pat. No. 4,775,219, JP-A-60-100103 and JP-A-6-50111.

The prismatic projections are most commonly cube corner projections and are integrally formed with a sheet-form base material to form the reflective article. The resin used to form the article is usually highly transparent, having a refractive index of 1.4 to 1.7. Examples of such resins include acrylic resins, epoxy-modified acrylic resins, polycarbonate resins. The prismatic projections typically used in these article are triangular pyramids, although they may have other shapes if desired. The prismatic sheet is often combined with a seal layer in order to protect the prismatic projections. The reflective article may then be adhered to a substrate.

The reflective sheet may be produced, for example, as follows. First, the prismatic sheet may be placed into contact with the seal layer. The seal layer and the prismatic sheet are then heat embossed at predetermined locations. This forms a bond between the two and provides a raised portion on the seal layer where it has been bonded to the prismatic sheet. The prismatic projections in the area between bonds are spaced apart from the seal layer. See, for example, U.S. Pat. No. 4,025,159.

U.S. Pat. No. 5,882,796 shows another type of reflective sheet. In this sheet, an adhesive layer is provided between the raised walls and the prismatic projections. See especially FIG. 7.

JP-A-2001-21708 discloses the use of columnar elements to bond a seal layer to a prismatic sheet. Other reflective articles are disclosed in U.S. Pat. No. 4,025,159, U.S. Pat. No. 5,946,134, and U.S. Pat. No. 5,910,858.

Thus, the prior art discloses three methods for the manufacture of reflective sheets. They are

1. Selective heat-sealing a prismatic sheet free of raised walls to a seal layer.

2. Selectively forming raised walls on a seal layer and subsequently adhesively attaching these raised walls to the prismatic sheet.

3. Integrally forming raised walls on a prismatic sheet and subsequently adhering these raised walls to the seal layer.

Each of the foregoing methods and articles resulting from the methods has certain disadvantages. For example, heat-sealing the seal layer to the prismatic sheet requires the use of pressure and relatively high temperatures (e.g., 200 to 250° C.). These conditions frequently result in the deformation of the prismatic projections at and near to the area of bonding. This leads to a deterioration of the retroreflective properties of the finished article.

Adhering the raised walls of the seal layer to the prismatic sheet via an adhesive provides only a point-to-point contact between the seal layer and the prismatic projections. Thus, in this approach, the tops of the raised projections are adhered to only the tips of the prismatic projections through an adhesive. This is a very small area of contact. Adhering the raised walls of the prismatic sheet to the seal layer via an adhesive also provides only a point-to-point contact. Like the previous approach, this also provides only a small area of contact. As a result, it is easy in both approaches for the bond to fail because of the environmental stresses placed on it due to repeated changes in temperature and humidity. These stresses cause the article to go through repeated contraction and expansion cycles. This often leads to cohesive failure at the bonds.

### SUMMARY

The present invention overcomes these disadvantages of the prior art. In one embodiment the present invention provides a reflective article that comprises a reflective laminate having:

a prismatic sheet which has a back surface having a plurality of prismatic projections and a front surface opposite to the back surface. The prismatic projections reflect light incident on the front surface of the prismatic sheet. A support having a first surface with a plurality of raised walls on it and valleys between the raised walls, and a second surface opposite the first surface is adhered to the prismatic layer by an adhesive layer on the first surface of the support. The adhesive adheres the raised walls of the first surface of the support to the prismatic projections of the prismatic sheet. A gap or space between the support and the prismatic sheet is present in those areas between the raised walls of the support.

In yet another embodiment, the present invention provides a method of making the reflective sheet. The method comprises the steps of:

(a) providing the prismatic sheet and the support as disclosed above;

(b) contacting the raised walls of the support to the prismatic projections of the prismatic sheet;

(c) maintaining a separation between the prismatic projections and the support in the regions of the valleys on the support;

(d) applying sufficient heat and pressure to the structure to secure the prismatic sheet and the support together.

The resulting article of the invention is then cooled to room temperature.

The article of the present invention provides a reflective laminate that can employ standard prismatic sheeting. That is, it is not necessary to utilize sheeting that has especially designed features to facilitate its bonding to another surface. It also provides an article that effectively enhances the adhesion of the prismatic sheet to the surface to which it is bonded to without resort to an emboss bonding method. As a result, the present invention avoids the problem of deforming the prismatic projections thereby preserving the retroreflective properties of the article.

### DESCRIPTION OF THE DRAWINGS

FIG. 1 is a sectional view of one embodiment of the reflective article of the invention;

FIG. 2 is a plan view of one embodiment of a support used in the present invention and specifically is a plan view of the support used in the embodiment of FIG. 1; and

FIG. 3 is a edge view of the support in FIG. 2.

### DESCRIPTION

In the reflective laminate of the invention, the raised walls of the support are formed before the prismatic sheet is adhered to it. Additionally, the adhesive layer is in close contact with the tip ends of the prismatic projections and the tops of the raised walls. As a result, the adhesion between the raised walls and the prismatic sheet (e.g., the peel strength when peeling the prismatic sheet from the raised walls) is effectively enhanced without employing the emboss-bonding method. This is achieved because (1) the contact area of between the raised walls and the prismatic projections is increased. Therefore peeling of the adhesive layer from the tip ends of the raised walls is made substantially more difficult as the ratio of the entire adhesive layer in contact with the projections is increased.

The raised walls rise from the first surface of the support toward the prismatic sheet. They extend a desired length along the first surface in a plane horizontal to the first surface. The area of the tops of the raised walls is relatively large so that the bond strength between the raised walls and the prismatic sheet is enhanced.

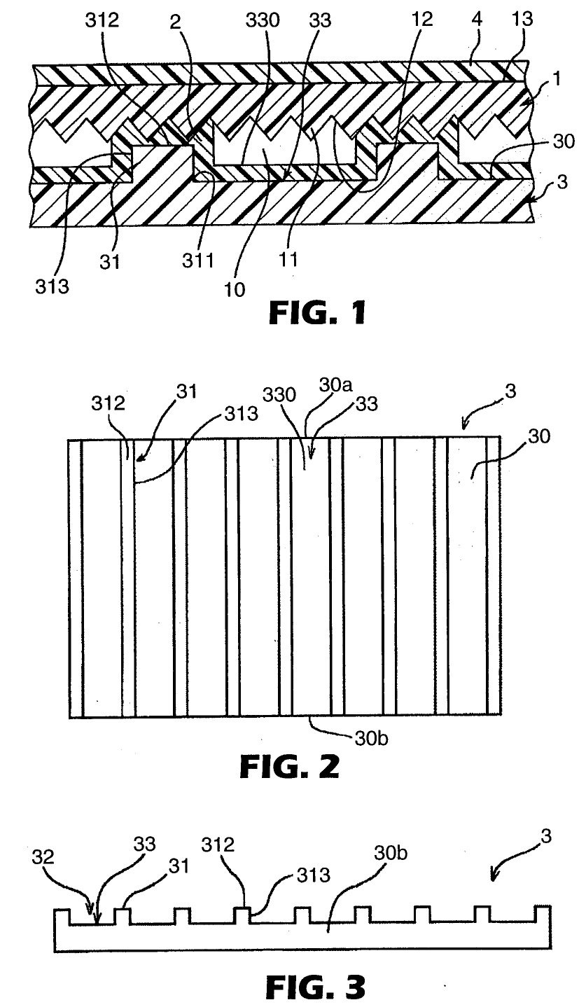

A preferred embodiment of the reflective article of the invention is described with reference to the accompanying drawings. As shown in FIG. 1, the reflective article of the invention comprises a prismatic sheet 1 and a support 3 adhered thereto. Raised walls 31 are integrally formed with, or alternatively bonded to, support surface 30 at a base end 311. Raised walls 31 are adhered to the tip ends 312 of the prismatic projections of prismatic sheet 1. Since the raised walls are an integral part of the support surface, when an external peeling force is applied, separation of the raised walls from the support is effectively prevented. This enhances the durability of the reflective article.

The raised walls 31 are formed as an integral part of the first surface 30 of the support 3 by processing or forming the support 3 before the adhering it to the prismatic sheet 1. Each of the raised walls 31 has a wall surface 313 extending along the lengthwise direction of the raised wall, a base end 311 and a top 312. The adhesive layer 2 is disposed so as to be in contact with at least the tops 312 and wall surfaces 313 of the raised walls 31. Preferably prismatic projections 11 are at least partially embedded in adhesive layer 2. Most preferably they are completely embedded in adhesive layer 2. Raised walls 31 usually have two mutually facing wall surfaces extending from both longitudinal sides of the tops 312. Valleys are formed between the mutually facing walls. In this case, the adhesive layer 2 is preferably in contact with both wall surfaces. In the illustrated example, the adhesive layer 2 is made of an adhesive film, and is continuous so as to be in contact entirely with the first surface 30.

The prismatic sheet 1 has a plurality of prismatic projections 11 on its back surface 12. Of the plurality of prismatic projections 11, the prismatic projections not contacting with the adhesive layer 2 are exposed to a space 10 formed between two adjacent raised walls 31. A plurality of prism-exposing spaces 10 are formed, and they are adjacent to each other across the raised walls 31. A front surface 13 opposite to the back surface 12 of the prismatic sheet is a light incident plane for receiving light from outside. The light entering the front surface 13 can be reflected by the prismatic projections 11 as in the case of a conventional prismatic reflective sheet.

The illustrated reflective laminate can be manufactured by providing the prismatic sheet and the support; contacting the raised walls of the support to the prismatic projections of the prismatic sheet; maintaining a separation between the prismatic projections and the support in the regions of the valleys on the support; applying sufficient heat and pressure to the structure to secure the prismatic sheet and the support together, and optionally cooling the resulting article to room temperature. The level of heat and pressure employed is sufficient to adequately adhere the prismatic sheet to the support without deforming the prismatic projections. For example, the adhesive layer 2 can be placed on the first surface 30 of the support 3 so as to be in contact with the tops 312 and wall surfaces 313 of the raised walls 31, and a bottom 330 of a valley 33 formed between the adjacent raised walls. The prismatic sheet 1 is then pressed onto the adhesive layer 2 so as that the prismatic projections contact adhesive layer 2. Sufficient pressure is applied to at least partially embed the prismatic projections into the adhesive layer 2. The pressure applied is usually from 50 g/cm² to 50 kg/cm² (about 5 kPa to 4.9 MPa).

If the adhesive layer contains a crystalline polymer, it is preferable to use heat during this step so as to adhere the prismatic sheet tightly to the adhesive layer. Typically, the temperature used is in the range of 60 to 150° C. The exact temperature used is dependent on certain factors such as the melting point of the crystalline polymer, the heat resistance of the prismatic sheet and/or the support, etc. The thickness of the adhesive layer employed in the present invention is not particularly limited. Preferably the thickness is in the range or from about 20 to 200 μm, and more preferably from 30 to 150 μm.

The shape and arrangement of the raised walls are not particularly limited as long as the spaces are formed for exposing the prismatic projections between the adjacent raised walls along the width direction. For example, as shown in FIGS. 2 and 3, the plurality of the adjacent raised walls 31 are extended continuously and in parallel from one end 30a to the other end 30b of the support surface 30. Alternatively, the plurality of raised walls may form cells with surrounding the exposed spaces.

The vertical cross-sectional shape of the raised walls shown is a quadrangle as shown. Typically the quadrangle is rectangular or trapezoidal. In the case of a trapezoid, the top is preferably narrower than the bottom (base). The vertical cross-sectional shape may also be curved, i.e., it may be substantially semicircular or semiellipsoidal. Preferably the top of the wall will be flat.

In the embodiment shown, openings 32 are formed at the end portions of the support. The openings and the prismatic projections between the walls communicate with each other. When such a reflective article is used outdoors, it is preferably oriented so that the raised walls are nearly horizontal. This orientation avoids or minimizes the ability of rainwater, dust or foreign matter to enter into the exposed spaces.

Preferably the openings 32 are closed. This can be achieved through the use of a seal tape or some other sealing member. Seal tape is an adhesive tape with a base material made of a resin with a large elongation at break (usually at least 100%). An ethylene-acrylic acid copolymer is an example of a useful sealing tape base material. The seal member is typically a resin composition which, after being applied, becomes solid either by virtue of being dried or cured. Alternatively, the peripheral edges of the reflective article may be surrounded with a frame to close the openings.

As noted above, a conventional prismatic sheet may be used in the present invention. This sheet can be manufactured by the methods disclosed in the references cited herein. A resin for forming the prismatic sheet is a highly transparent resin with a refractive index in the range of 1.4 to 1.7, for example, an acrylic resin, an epoxy-modified acrylic resin, and a polycarbonate resin. The total light transmission of such a resin is usually at least 70%, preferably at least 80%, and more preferably at least 90%.

The shape of the prismatic projections used in the invention may be the same as those conventionally used (which are disclosed, for example, in U.S. Pat. No. 4,775,219). Also the dimensions and arrangement of the prismatic projections may be the same.

When the reflective laminate is used outdoors, it is preferable to cover the surface 13 of the prismatic sheet with a protective film 4. The protective film is, for example, a transparent polymer film containing an ultraviolet absorber.

Support 3 is usually a plate or a sheet comprising a metal, resin or wood. As the metal, stainless steel, aluminum may be used. As the resin, relatively rigid plastics are preferable, and, for example, polycarbonate, polyimide, an acrylic resin, polyethylene, or polypropylene may be used. The thickness of the support is usually from 250 μm to 10 mm. The thickness of the support is not critical to the present invnetion as long as the effects of the invention are not impaired. The support may be light-transmitting, and in such a case, the reflective laminate may be used as an internally illuminated signboard or marker panel. Alternatively, the support surface may be colored using a paint containing a colorant (a pigment or a dye).

Preferably, the raised walls are integrally formed in the support when it is fabricated. For example, the support as shown in FIGS. 2 and 3 can be manufactured by extrusion molding. Alternatively, a support having a flat surface may be processed by milling or cutting, and groove may be cut off, to form the raised walls. Furthermore, a mold with a cavity having the negative of the desired shape and arrangement, and the dimensions of the raised walls may be used. The raised walls can be formed by pressing the mold to a flat support surface with heat.

When forming the support from a resin, the following integral forming method is preferable. A liquid-state resin is poured into the cavity of the mold. The resin is shaped by solidifying it while in contact with the mold. Solidification of the resin is carried out by cooling of the molten resin, or curing the curable resin, and so on. Furthermore, the liquid resin poured in the mold cavity is solidified while being in contact with a substrate for an information display panel, and thus a support consisting of a laminate in which the substrate and the support with raised walls tightly adhere can be formed.

The raised walls can also be formed without forming them integrally with the support. For example, after transferring a curable resin in the form of raised walls, the resin can be cured to form the raised walls coupled to a substrate. The curable resin is preferably light curable to be cured by ultraviolet rays or electron beams.

A preferred support is a metal plate or a metal sheet processed or formed so that the support and the raised walls may be bonded integrally. Such a support can be used as a substrate for an information display panel, and is hence advantageous in that the reflective laminate can be formed in a structure requiring no extra adhesive layer as mentioned above. To form such a metal support in the following manner is beneficial because the support with raised walls can be fabricated easily.

The support is preferably fabricated as a substrate for an information display panel (a sign panel, a signboard, a guide display panel). To manufacture an information display panel using a reflective sheet, which is formed by bonding a seal layer and a prismatic sheet with inserting raised walls between them, a retroreflective sheet is adhered to a metal substrate such as an aluminum substrate. In this case, in order to adhere the seal layer to the substrate, an adhesive layer should be separately disposed on the back surface of the seal layer, or an adhesive layer should be disposed preliminarily on the substrate surface. The seal layer is usually a flexible resin film, and its thickness is hundreds of microns (less than 1 mm) at most. Its rigidity is low. The seal layer itself cannot be used as a substrate because of its flexibility. It has recently become desirable to fabricate an information display panel more easily than ever. As a result a substrate for an information display panel is preferably used as a support. The raised walls are integrally bonded to the substrate surface. In this manner, a reflective laminate having a structure not requiring an extra adhesive layer as mentioned above may be formed.

The percentage of the area in which the raised walls and the adhesive layer are in contact with each other (contact area) based on the entire area of the back surface of the prismatic sheet is usually 10 to 50%, preferably 20 to 45%, and more preferably 21 to 40%. If the contact area is too small, the adhesion strength between the raised walls and the prismatic sheet may be not enhanced effectively, or if too large, the retroreflective performance may be lowered.

Other dimensions of the raised walls are not particularly critical to the invention as long as the effects of the invention are not sacrificed. The height of the raised walls is usually 80 to 700 μm, preferably 100 to 500 μm. The width of the top of the raised walls is usually 0.3 to 7 mm, preferably 0.5 to 5 mm.

When the raised walls extend in parallel with each other on the first surface, the interval of the adjacent raised walls is usually 0.5 to 10 mm, preferably 1 to 7 mm. When forming cells surrounded with raised walls, the area of each cell is usually 3 to 40 mm², preferably 5 to 30 mm².

The support may be an assembly combining a plurality of support units. For example, when an information display panel made of a reflective laminate is formed, it is a support containing an assembly of a plurality of support units each having a smaller surface than the surface of the entire information display panel. In this case, each one of the support units has a unit surface and at least one unit raised wall fixed on the unit surface, and when the support units are combined, the unit surfaces are combined to form the entire support surface, and the unit raised walls are combined to form the raised walls to be disposed on the entire support surface.

When a substrate for an information display panel is formed from a support with raised walls, the raised walls must be formed by processing or molding the surface having a relatively large area. In such a case, whole or almost all part of the support is preferably formed from an assembly comprising a plurality of support units. When the raised walls are formed on the substrate surface having a relatively large area, it is not easy to increase the precision of processing or forming. In such a case, the heights of the raised walls become less uniform, and the adhesion strength to the prismatic sheet may not be effectively enhanced in part. On the other hand, when the support (substrate) is formed of a plurality of units, the area of each unit surface can be considerably decreased, and it is very easy to increase the precision in height of the raised walls. Therefore, when a support is formed from a plurality of units, a substrate having a relatively wide display area can be formed easily, and the adhesion strength of the raised walls to the prismatic sheet can be effectively enhanced.

When the support is formed from the combination of support units, (1) the entire support is finished, and then the prismatic sheet is adhered to the support to manufacture the reflective laminate, or (2) a reflective laminate unit is formed by adhering a prismatic sheet having the same surface area as its unit to the support unit, and the reflective laminate units are combined to finish the reflective laminate.

The shape of the support unit is usually rectangular. The dimensions of each support unit are not critical, and may be vary depending on the use of the reflective article. To form the raised walls easily, preferably, the shorter side of rectangle is small, or the surface area is relatively small. Usually, the longer side is about 5 to 500 cm while the shorter side is 2 to 100 cm, and in the case of a square plane shape, usually, each side is 10 to 100 cm.

To adhere the adhesive layer to the tops of the raised walls and the wall surfaces, a flat adhesive film (solid state at room temperature, about 25° C.) is laminated to the tops of the raised walls, and pressure is applied while heating, as required, and the adhesive film is deformed.

When a plurality of raised walls form cells of prismatic projections, it is relatively difficult to adhere the adhesive layer to the tops of the raised walls and the wall surfaces. For example, when a flat adhesive film is deformed so as to contact also with the wall surfaces, bubbles are likely to be trapped between the wall surfaces of the raised wall and the adhesive film. The bubbles may not be removed completely because there is no escape route for the bubbles. In such a case, vent holes penetrating from the front surface to the back surface are provided in the support corresponding to the bottoms of the cells, or the adhesive film is provided with vent holes so that the vent holes penetrate from the adhesive surface to the back surface on the opposite side.

In such a case, to easily remove bubbles between the wall surfaces of the raised wall and the adhesive film, as shown in FIGS. 2 and 3, it is preferable to use a support having grooves, which extend continuously from one end to other of the support surface and have an opening at least at one end of the support surface, between the raised walls. If bubbles are trapped between the wall surfaces of raised walls and the adhesive film, the bubbles can easily escape through these openings. At least one opening is enough, but openings may be provided at both ends of the groove. If a compression process is used to adhere the adhesive film to the raised walls, it is preferable to include a vacuum compression operation, because the bubbles can escape very easily between the wall surfaces of the raised walls and adhesive film.

Advantageously, the bubbles escape from the wall surfaces and the adhesive film, when the vertical sectional shape of the raised wall (cut along the width direction) is trapezoidal, or the coupling angle between the tip end and the wall surface is an obtuse angle, or the tip end portion is flat and nearly semicircular or semielliptical so that the wall surface has a convex curve upwardly.

The adhesive composition employed in the invention is not critical, and is usually a heat sensitive adhesive. Alternatively, an adhesive, which can be cured after adhering the prismatic sheet to the support, may be used.

As mentioned above, the adhesive layer should be adhered at least to the tops of the raised walls and the wall surfaces. If the adhesive layer is flowable at room temperature, it may not be firmly retained on the raised walls for a long period. However, the production of the reflective article is facilitated, when the adhesive layer is disposed on the top of the raised walls and the wall surfaces. The prismatic sheet and the raised walls can be adhered to one another by pressure alone or by the use of heat and pressure. It is preferable to form an adhesive layer using an adhesive composition showing an adhesion as high as possible during the compression step and showing as high a peel strength as possible resistance to peeling of the prismatic sheet from the raised walls in the use of the reflective laminate.

An adhesive composition meeting such requirements is one that satisfies the following conditions:

1) the adhesive should contain a self-adherent polymer and a crystalline polymer, and

2) the self-adherent polymer and crystalline polymer should be mutually compatible at a temperature above the melting point of the crystalline polymer.

Such an adhesive composition is excellent in the following points.

(I) When the adhesive contains a crystalline polymer, it acts to lower the fluidity of the adhesive layer. In particular, it is preferable to use the mutually compatible combination of the self-adherent polymer and the crystalline polymer at a temperature above the melting point of the crystalline polymer to adhere the prismatic sheet and the raised walls by thermally compressing at a temperature above the melting point of the crystalline polymer. This is because the fluidity of the adhesive layer is effectively lowered after bonding and the adhesive layer is bonded strongly to the raised walls.

(II) Since the adhesive contains the self-adherent polymer, the prismatic sheet and the support can be adhered only by compression or thermal compression.

(III) Since the crystalline polymer and the self-adherent polymer are mutually compatible, the adhesive composition shows a high tackiness during compression, while it shows a high peel strength during the use of the reflective laminate. Furthermore, this adhesive composition forms an adhesive film, which is solid at room temperature (about 25° C.).

To further enhance the cohesive failure strength of the adhesive layer, it is preferable to crosslink the self-adherent polymer. The cohesive failure strength of the adhesive layer may be further enhanced effectively by compounding an inorganic pigment dispersed in the adhesive containing the self-adherent polymer and the crystalline polymer. It is preferable to use both the crosslinked self-adherent polymer and the inorganic pigment.

The composition used to make the adhesive layer can be prepared by uniformly mixing the self-adherent polymer, the crystalline polymer and a solvent. When an inorganic pigment is contained, it can be added to the same composition. Mixing can be carried out using a usual dispersing apparatus, sand mill, planetary mixer, or the like.

The composition can then be applied to a liner or a support. If it is formed on the liner, the adhesive layer may be transferred from the liner to the support, and then adhered to the prismatic sheet to form the reflective laminate. The application operation may be carried out by using standard such as by knife coating, bar coating, roll coating or die coating.

The coating film is usually dried at a temperature of 60 to 180° C. The drying time is usually about tens of seconds to several minutes.

The coating composition is usually prepared by dissolving a self-adherent polymer and a crystalline polymer uniformly in a solvent to form a vehicle, and dispersing an inorganic pigment uniformly in the vehicle. Alternatively, a monomer mixture containing a monomer which forms a self-adherent polymer after polymerization and a crosslinking agent monomer, and a crystalline polymer are mixed, and the mixture is used as a vehicle. When the monomer mixture is used, the composition containing the monomer mixture is applied on an object to be coated such as a liner or a substrate, and it is irradiated with ultraviolet rays or electron beams to polymerize (or to polymerize and crosslink) the monomer, and thus the adhesive layer is formed.

Other additives may be added to the adhesive layer if desired. These may include, for example, a tackifying resin, a non-crystalline and non-tacky thermoplastic polymer, a plasticizer, an organic pigment, polymer particles, a dyestuff, an ultraviolet absorber, and a surfactant. The amount of such an additive used in the adhesive layer is usually 30% by weight or less.

The self-adherent polymer used in the present invention is a polymer which is tacky at room temperature (about 25° C.). Examples of the self-adherent polymer include an acrylic polymer, a nitrile-butadiene copolymer (NBR), a styrene-butadiene copolymer (SBR), amorphous polyurethane, and a silicon-based polymer. The self-adherent polymers can be used independently or as a mixture of two or more of them.

Preferably, the self-adherent polymer is a crosslinkable polymer which contains (a) an photo-crosslinkable functional group having an unsaturated double bond, an aromatic ketone structure or (b) a crosslinkable functional group such as a hydroxy group, a carboxyl group in a molecule. In addition to the crosslinkable functional group, the polymer preferably contains an alkyl group and/or an aryl group with 4 to 8 carbon atoms, or a polar group other than the above crosslinkable functional group, in the molecule. The aryl group is a functional group having a benzene ring in its chemical structure. Examples of aryl groups include a phenyl group, a phenoxy group, a benzyl group, a benzoyl group, a naphthyl group, a biphenyl group. Preferable examples of the polar group include a nitrile group, a pyridine group, an alkyl di-substituted amino group, and other nitrogen-containing functional groups. The number of carbon atoms in the alkyl group is more preferably 6 or less (that is, 4, 5 or 6 carbon atoms).

The content of the monomer units containing the alkyl group and/or aryl group (repeating units derived from the starting monomer having the alkyl group or aryl group respectively) included in the self-adherent polymer is usually 60 to 99 mol %, and preferably 70 to 98 mol %.

An example of the self-adherent polymer usable in the invention is an acrylic polymer obtained by polymerizing a monomer mixture containing (i) an acrylate monomer having an alkyl group with 4 to 8 carbon atoms in a molecule, and/or an acrylate monomer having an aryl group in a molecule, and (ii) a (meth)acrylate having a crosslinkable functional group in a molecule.

Examples of the monomer (i) include n-butyl acrylate, isobutyl acrylate, 2-methylbutyl acrylate, 2-ethylhexyl acrylate, isooctyl acrylate, phenoxyethyl (meth)acrylate, and phenoxypropyl (meth)acrylate. Examples of the monomer (ii) include (meth)acrylic acid, fumaric acid, itaconic acid, 2-hydroxyethyl (meth)acrylate, 2-hydroxypropyl (meth)acrylate, and hydrxo-3-phenoxypropyl (meth)acrylate.

Such an acrylic polymer can be prepared using the starting monomer mixture containing the component monomers in a specified ratio, and copolymerizing the monomers by a usual method, such as bulk polymerization, solution polymerization, suspension polymerization, and emulsion polymerization.

The glass transition temperature of the self-adherent polymer is usually −50 to 10° C., preferably −40 to 5° C., more preferably −30 to 0° C. The molecular weight of the self-adherent polymer is not particularly specified as far as the specified adhesion is exhibited, and usually it is in a range of weight-average molecular weight of 10,000 to 1,000,000.

The self-adherent polymer is preferably crosslinked. For example, when the crosslinkable functional group is a carboxyl group, a bisamide crosslinking agent, an epoxy resin, an isocyanate compound may be preferably used as a thermal crosslinking component. When such a crosslinking compound is used, the amount of the crosslinking component in the entire adhesive composition (total weight) is usually 0.01 to 20% by weight, preferably 0.05 to 10% by weight.

The amount of the self-adherent polymer in the entire adhesive layer is usually 30 to 60% by weight, preferably 31 to 55% by weight. If the amount of the self-adherent polymer is too small, the adhesion of the adhesive layer to the raised walls may be lowered. If the amount of the self-adherent polymer is too large, the cohesive failure strength of the adhesive layer may be lowered.

Crystalline Polymer.

A crystalline polymer is a polymer which is crystallized at room temperature (about 25° C.). Usually, it has a melting point above 25° C., and it is crystallized at a temperature lower than the melting point. The melting point of the crystalline polymer measured by DSC (differential scanning calorimeter) is usually 40 to 120° C., preferably 45 to 100° C. When a crystalline polymer having a relatively low melting point, the prismatic sheet and the support can be adhered at a low temperature (about 120° C. or less) to prevent the decrease of luminance due to the thermal deformation of prismatic projections.

The molecular weight of the crystalline polymer is usually in a range of 2,000 to 200,000, preferably 3,000 to 100,000 in terms of a weight-average molecular weight. In this specification, the molecular weight is the styrene converted molecular weight measured using GPC.

The crystalline polymer includes polycaprolactone polyol, polycarbonate polyol, and polyurethane synthesized by the reaction of these polyols with diisocyanates. Such polyurethane is useful for enhancing the peeling strength between the raised walls and the adhesive layer.

A preferable combination of the mutually compatible crystalline polymer and self-adherent polymer is the self-adherent polymer having an aryl group in the molecule mentioned above, and the crystalline polymer having repeating units composed of an alkylene group with 4 to 6 carbon atoms in the molecule. In such a combination, a particularly preferable example of the crystalline polymer is polycaprolactone or polyurethane having repeating units derived from 1,6-hexanediol dicarbonate.

The amount of the crystalline polymer in the entire adhesive layer is usually 5 to 55% by weight, preferably 10 to 50% by weight. If the amount of the crystalline polymer is too small, the room temperature tack of the adhesive layer increases, and the cohesive failure strength may be lowered. Furthermore, if the amount of the crystalline polymer is too small, the thermal adhesion of the adhesive layer may be lowered. On the contrary, if the amount of the crystalline polymer is too large, the adhesion of the adhesive layer to the raised walls is lowered, and the peeling strength between the prismatic sheet and the raised wall may be lowered.

Inorganic Pigment.

The inorganic pigment is usually a white or non-white coloring pigment. For example, titanium oxide, zinc oxide, silicon dioxide, alumina, zirconia, or iron oxide may be used. The pigment may be a fluorescent pigment as far as the effects of the invention are not impaired. The amount of the inorganic pigment in the entire adhesive layer is usually 5 to 20% by weight, preferably 10 to 15% by weight. If the amount of the inorganic pigment is too small, the cohesive failure strength may be lowered. On the contrary, if the amount of the inorganic pigment is too large, the adhesion between the adhesive layer and the raised walls may be lowered.

### EXAMPLES

### Examples 1 to 10

These Examples are examples of the fabrication of a reflective article of the invention having the structure shown in FIG. 1, using a support having the shape shown in FIGS. 2 and 3.

The prismatic sheet used was a retroreflective prismatic sheet having cube corner prisms as prismatic projections. The prismatic sheet was fabricated by an integral forming method using a mold of a polycarbonate resin, by the method disclosed in the prior art mentioned above. In this forming method, a protective layer of 50 μm in thickness was adhered to the surface of the prismatic sheet (surface of the land). This protective layer was a polymethyl methacrylate film containing an ultraviolet absorber. The land thickness of the prismatic sheet (a distance from the base or root of the prismatic projection to the surface of the prismatic sheet) was 150 μm, and the height of the prismatic projections was 90 μm.

The adhesive layer was manufactured in the following procedure. First, a composition for forming an adhesive layer was fabricated. Crystalline polymer (C), self-adherent polymer (S), inorganic pigment (P), and crosslinking agent (L) for a self-adherent polymer were mixed at a ratio of 35:52:13:0.2 (nonvolatile component ratio) (C:S:P:L). The components excluding the crosslinking agent were mixed together with a solvent using a sand mill, and a uniform dispersion was prepared, and before application, the crosslinking agent was added to the dispersion, and a paint for an adhesive layer was obtained. The solvent was a mixed solvent of toluene and ethyl acetate, and the nonvolatile concentration of this composition was 33% by weight.

The crystalline polymer used was crystalline polyurethane (Mn=8,900, Mw=34,000) obtained by the polymerization of 1,6-hexanediol carbonate (PLACCEL® CD-220, Daicel Chemical Industries, Corp.) and isophorone diisocyanate. The melting point of this polyurethane measured by the DSC was 50° C.

The self-adherent polymer used was prepared by the polymerization of a mixed monomer solution containing phenoxyethyl acrylate, butyl acrylate, 2-hydroxy-3-phenoxy propyl acrylate, and acrylic acid at a weight ratio of 55:25:15:5 (using a mixed solvent of toluene and ethyl acetate; nonvolatile concentration, 30% by weight).

The inorganic pigment was white titanium oxide (CR-90 of Ishihara Industries, Ltd.). The crosslinking agent was a bisamide crosslinking agent.

The paint for an adhesive layer obtained in the above was applied at a bar set of 330 μm on the releasing surface of a liner (silicone-release-treated polyester film of Teijin DuPont, thickness=50 μm), and dried at 65° C. for 3 minutes and then at 100° C. for 2 minutes, and an adhesive layer in the form of a solid film in 60 μm in thickness was obtained.

As the material for the support, an aluminum substrate having a flat rectangular shape and a thickness of 3 mm (A5052P alloy specified in JIS H 4000) was used, and it was processed by milling, and a plurality of raised walls of the same dimension were formed. As shown in FIGS. 2 and 3, the raised walls extended in parallel with each other from one end to other end in the lengthwise direction of the support surface, and grooves, which had openings at both ends in the lengthwise direction of the support surface and extended in parallel with each other, were formed between the adjacent raised walls.

In each Example, the supports identified with symbols A to J as shown in Table 1 were used. The dimensions of the raised walls and grooves of the supports are also shown in Table 1. In all Examples, the length of the support in the extending direction of the raised wall was 150 mm, and the dimension in the width direction was adjusted in each Example so that the raised walls may be disposed at both ends in the width direction of the support. The support width of the reflective laminate fabricated for the evaluation of adhesion strength was adjusted to about 25 mm, and the support width of the reflective laminate fabricated for the evaluation of retroreflection performance was adjusted to about 70 mm. The groove depth (raised wall height) was 130 μm in all examples. The symbols of the supports used in each Example are shown in Table 2. In Table 2, in the reflective laminate for the evaluation of adhesion strength, the percentage of the area (adhesion area) of the raised wall contacting through the adhesive layer based on the entire area of the prismatic sheet is expressed as a raised wall occupancy.

Using the prismatic sheets, the adhesive films (adhesive layers) and the supports manufactured as described above, the reflective laminate of each Example was finished in the following procedure.

(1) Transfer of adhesive layer to support surface

After the support surface was degreased with a degreasing agent of Sumitomo 3M (FEY-0180), an adhesive film with a liner was laminated on the support so that the adhesive film was in contact with the tip ends of the raised walls of the support. Then, using a 3M vacuum compression apparatus (Heat Lamp Vacuum Applicator), the adhesive film was press adhered to the entire support surface at a heating temperature of 75° C. for a heating time of 90 seconds. Just after the completion of vacuum compression, the liner was peeled off from the adhesive film, and a polyethylene film having a thickness of 40 μm was laminated instead, and the adhesive film was pressed toward the support surface through the polyethylene film using a silicone hand roller with a rubber hardness of 30. As a result, the adhesive film was adhered to the tip ends of the raised walls, the wall surfaces and the groove bottoms.

(2) Heat lamination of prismatic sheet

The polyethylene film was peeled off from the support with the adhesive film fabricated in step (1), and the sheet was heated in an oven at 90° C. for 5 minutes. Just after being taken out from the oven, the prismatic sheet was laminated on the adhesive film, and the raised walls and the prismatic sheet were heated and compressed using a heat laminator comprising a heatable steel roll and a robber roll. As a result, the reflective laminate of each Example was completed. In this thermal compression operation, the prismatic sheet was kept in contact with the steel roll. The surface temperature of the steel roll was 85° C., the clearance between the steel roll and the rubber roll was 3 mm, and the transfer speed of the laminator was 0.64 m/min. The surface of the prismatic sheet of the completed reflective laminate was observed, and clear straight white lines were observed in the portions corresponding to the raised walls, and the retroreflectivity completely disappeared in these areas.

The reflective laminates manufactured in this manner were evaluated as follows. In all evaluations, the reflective laminates kept at room temperature for 7 days after thermal compression were used as samples. Results of evaluation are summarized in Table 2.

Retroreflective Performance.

Using a luminance measuring apparatus (Model 920 of Gamma Scientific), a luminance was measured at three arbitrary points on the surface of the prismatic sheet. The average of the luminances was used as the retroreflective performance. The retroreflective performance of the prismatic sheet before being adhered to the support was 732 cd/lux/m².

Brightness Rate β (%).

The brightness rate β was measured using the SM Color Computer® Model SM-7 of Suga Ltd. according to the color measuring method specified in JIS Z 9117. The measuring condition included a D65 light source and a viewing angle of 2 degrees. The brightness rate β is effective as an index for brightness and whiteness. When the value of β exceeds 40, the reflective plane of the reflective laminate can be seen white, and the larger value means a higher degree of whiteness. This brightness rate β is equivalent to the reflectivity Y value in the Yxy color indication.

Adhesion Strength.

The peeling strength was measured by peeling the prismatic sheet from the reflective laminated along the lengthwise direction of the support, and used as the adhesion strength. The peeling condition included a pulling rate of 300 mm/min and a peeling angle of 90 degrees.

### Example 11

A reflective laminate of this Example was manufactured in the same manner as in Example 9 except that the ratio (C:S) of the crystalline polymer (C) to the self-adherent polymer (S) was changed from 35:52 to 52:35.

### Example 12

A reflective laminate of this Example was manufactured in the same manner as in Example 9 except that the following non-crystalline and non-tacky thermoplastic polymer (B) was added, and that the nonvolatile content ratio (C:S:P:L:B) of the crystalline polymer (C), the self-adherent polymer (S), the inorganic pigment (P), the crosslinking agent (L), and the thermoplastic polymer (B) was set at 35:36:13:0.2:16. This thermoplastic polymer was polyurethane (Mn=7,800, Mw=34,000) obtained by polymerizing polycarbonate diol (PLACCEL CD-220PL of Daicel) and isophorone diisocyanate.

Examples 11 and 12 were evaluated by the same methods as those in Example 1, and the results are recorded in Table 2.

### Comparative Example 1

This Comparative Example is an example of a retroreflective sheet fabricated by the emboss bonding method using the same prismatic sheet as one used in the Examples and a seal layer comprising a thermoplastic resin composition.

This retroreflective sheet formed cells (each having a hexagonal contour) with surrounding the prism exposing spaces by a plurality of raised walls. The raised wall occupancy was 27%.

This retroreflective sheet was compressed using the heat laminator mentioned above on an aluminum sheet of 1 m in thickness (A5052P alloy specified in JIS H 4000), and it was used as a sample, and the retroreflective performance and brightness rate β (%) were measured, and 450 cd/lux/m² and 45.3% were obtained respectively.

### Comparative example 2

This Comparative Example is an example of a reflective sheet having the adhesive film adhered only to the tip ends of the raised walls, and not disposed at the wall surfaces or groove bottoms.

In this example, firstly, a short strip of an adhesive film was formed in the same width as the width of raised wall, this strip film was fitted tightly to the tip ends of the raised walls, and compressed by the same hand roller as one used above. The support, prismatic sheet and adhesive film were the same as those used in Example 9. The adhesive strength was measured by the same method as in the Examples, and 8 N/25 mm was obtained.

As understood from the comparison between the Examples and Comparative Example 1, the retroreflective performance was improved in the reflective laminate having the same raised wall occupancy when the emboss-bonding method was not employed. The close contact of the adhesive layer with the tip ends of raised walls and wall surfaces was effective for enhancing the adhesion strength of the raised walls to the prismatic sheet. When the raised wall occupancy was from 21 to 40%, a sufficiently high reflective performance was achieved, and an adhesion strength of high level exceeding 10 N/25 mm was attained.

The reflective laminates of the Examples have the sufficiently high retroreflective performance and brightness rate β, and are hence applicable as reflective laminate units. Therefore, a plurality of reflective laminates are provided and horizontally arranged to form an assembly having a wide reflective surface (the surface of a prismatic sheet), which can be used as a marker panel.

TABLE 1

Raised wall width

| | | 0.7 mm | 1 mm | 1.5 mm | 2 mm | 2.5 mm |
|---|---|---|---|---|---|---|
| Groove | 5 mm | — | A | B | C | D |
| width | 4 mm | — | E | F | G | — |
| | 3 mm | H | I | J | — | — |

TABLE 2

| | | Raised | | | Support width | | | |
|---|---|---|---|---|---|---|---|---|
| | | wall | Groove | Raised wall | (for evaluation of | | Retroreflective | |
| | Support | width | width | occupancy | adhesion strength) | Brightness | performance | Adhesion strength |
| | symbol | [mm] | [mm] | [%] | [mm] | rate β [%] | [cd/lux/m²] | [N/25 mm] |
| Example 1 | A | 1 | 5 | 20 | 25 | 42.3 | 615 | 9.1 |
| Example 2 | B | 1.5 | 5 | 27 | 27.5 | 43.6 | 538 | 11.5 |
| Example 3 | C | 2 | 5 | 33 | 30 | 44.5 | 522 | 10.6 |
| Example 4 | D | 2.5 | 5 | 40 | 25 | 47.2 | 456 | 13.4 |
| Example 5 | E | 1 | 4 | 23 | 26 | 42.0 | 574 | 12.7 |
| Example 6 | F | 1.5 | 4 | 31 | 29 | 44.7 | 511 | 14.7 |
| Example 7 | G | 2 | 4 | 38 | 26 | 48.5 | 462 | 16.8 |
| Example 8 | H | 0.7 | 3 | 21 | 22.9 | 43.0 | 572 | 11.6 |
| Example 9 | I | 1 | 3 | 28 | 25 | 44.3 | 504 | 16.5 |
| Example | J | 1.5 | 3 | 38 | 24 | 47.5 | 473 | 16.9 |
| 10 | | | | | | | | |
| Example | I | 1 | 3 | 28 | 25 | 44.0 | 523 | 13.1 |
| 11 | | | | | | | | |
| Example | I | 1 | 3 | 28 | 25 | 44.4 | 535 | 15.4 |
| 12 | | | | | | | | |

As shown above, the invention provides a reflective laminate using a standard prismatic sheet without employing the emboss bonding method which is likely to lower the retroreflective performance. The reflective article of the invention has the effectively increased adhesion strength between the raised walls and the prismatic sheet.

1. A reflective laminate comprising:
a prismatic sheet which has a back surface having a plurality of prismatic projections and a front surface opposite to said back surface, wherein said prismatic projections reflect light incident on said front surface of said prismatic sheet;
a support having a first surface having a plurality of raised walls on said first surface and valleys between said raised walls, and a second surface opposite said first surface;
an adhesive layer on said first surface of said support;
a gap between said support and said prismatic sheet;
wherein said adhesive adheres said raised walls of said first surface of said support are adhered to said prismatic projections of said prismatic sheet.

2. The reflective laminate according to claim 1, wherein said support is a substrate of an information-displaying board.

3. The reflective laminate according to claim 1, wherein said support comprises an assembly of a plurality of support units each of which comprises a unit surface and at least one unit raised wall fixed to said unit surface, and said unit surfaces of the substrate units are combined to form said front surface of the support, and said unit raised walls are combined to form said raised walls, when said substrate units are assembled.

4. The reflective laminate according to claim 1, wherein said adhesive layer comprises an adhesive containing a self-adherent polymer and a crystalline polymer which are compatible each other at a temperature higher than the melting point of said crystalline polymer.

5. The reflective laminate according to claim 1, wherein said support consists of a metal plate or a metal sheet, which is processed or formed so that said support and said raised walls are integrally bonded.
